(19) United States
(12) Patent Application Publication
(10) Pub. No.: US 2024/0239051 A1
(43) Pub. Date: Jul. 18, 2024

(54) Device, method and movable joining apparatus for thermal joining respectively two adjacent material sheets over a connecting piece

(71) Applicant: Leister Technologies AG, Kägiswil (CH)

(72) Inventors: Silvan Horand, Kriens (CH); Roger Bürgler, Ennetbürgen (CH)

(21) Appl. No.: 18/411,454

(22) Filed: Jan. 12, 2024

(30) Foreign Application Priority Data
Jan. 12, 2023 (EP) 23 151 276.5

(51) Int. Cl. B29C 65/12; B29C 65/00; B29C 65/30; A47G 27/04

(52) U.S. Cl. CPC B29C 65/12; B29C 65/30; B29C 66/8362; A47G 27/0443

(57) ABSTRACT

A device, a method and a movable welding apparatus for thermal joining of respective two material sheets over a connecting piece arranged areally on a bottom side, wherein the material sheets are arranged with a respective side surface facing one another abutting against each other at least partially with a respective bottom side lying areally on a top side of the connecting piece are provided. In particular, the two material sheets and the connecting piece can be joined together in one pass.

### CROSS-REFERENCE TO RELATED APPLICATIONS

This application claims the priority of European patent application No. 23 151 276.5, filed Jan. 12, 2023, which is incorporated herein by reference in its entirety.

### TECHNICAL FIELD

The present invention relates to a device, a method and a movable joining apparatus, in particular a movable welding apparatus, for thermal joining of two adjacent material sheets over a connecting piece lying areally on a bottom side, wherein the material sheets are arranged with a respective side surface facing one another abutting against each another at least partially with a respective bottom side lying areally on a top side of the connecting piece.

### BACKGROUND

Such material sheets typically consist of a partially meltable and/or meltable and/or fusible material. For example, the material sheets can consist of a plastic material, in particular a thermoplastic material. The material sheets can, however, also be for example bitumen sheets. They can, however, also be material sheets whose material is not partially meltable and/or meltable and which are on a bottom side at least partially provided with a thermally activatable adhesive, which is partially meltable and/or meltable.

The material sheets are configured in the form of a sheet or stripe and are therefore planar, in some cases with a surface structure. Compared to their lateral dimensions (length and width), the material sheets comprise only a small height (thickness or strength of the material). The same applies to connecting pieces, wherein the connecting pieces are usually significantly narrower than the material sheets for lengths comparable to those of the material sheets. The connecting pieces are therefore alternatively characterized as “web-shaped” in addition to “strip-shaped”.

The material sheets as well as the connecting pieces are typically provided in advance of the processing rolled-up on rolls and for processing are unrolled and laid on ground at the processing site. The ground can for example be a floor or a wall of a building and the material sheets are joined together in a liquid-tight manner to form a liquid-tight material layer on the ground to seal the ground against liquids that might otherwise penetrate or leak or escape, e.g. water. For example, (flat) roofs, basins, canals or tunnels can be sealed. Usually in the processing of the material sheets, after laying out the material sheets at the respective intended positions on ground, they are first fixed to the ground. In the thickness direction of a material sheet, that side of the two large planar sides of the material sheet opposite to each other, which lies areally on a top side of the ground when the material sheet is laid on the ground, is usually referred to as the bottom side of the material sheet. The other large planar side, which faces away from the top side of the ground, is accordingly referred to as the top side of the material sheet. In the following, the narrow outer edge(s) of a material sheet between the top side and the bottom side of the material sheet is/are referred to as the side surface(s). The same applies for the connecting pieces accordingly.

During processing of material sheets in usual applications, the material sheets are laid overlapping on ground and joined. Thereby, one material sheet lies on top of a directly adjacent material sheet along side surfaces of the material sheets facing each other, at least in a connecting region in the vicinity of their side surfaces facing each other, with a part of the bottom side on a part of the top side of the other material sheet. If the material sheets are, for example, thermoplastic material sheets, the material sheets can be at least partially plasticized by simultaneous and successive heating in sections in the connecting region and joined to one another under subsequent application of pressure in the connecting region. With the subsequent cooling of the heated material of the material sheets, an overlapping weld seam (overlap seam for short) is thus formed between the material sheets along the side surfaces of directly adjacent material sheets facing one another. The material sheet lying on top of the other material sheet in the connecting region is thereby successively heated in sections from its bottom side in the connecting region and the material sheet lying below in the connection region simultaneously from its top side. Thereby, automatic welding apparatuses with hot air welding devices or contact welding devices (‘heating wedges’) known from the prior of the art are often used for heating the material sheets to be connected. Accordingly, the joining of the material sheets and, if necessary, fixing the material sheets on ground can be performed quickly and efficiently.

In some applications, an overlapping laying and joining of material sheets is undesirable. This can for example be for aesthetic reasons. A joint material layer resulting from overlapping laying and joining of material sheets is not smooth on the top side or surface due to the overlap and at the overlap seams comprises seam transitions in the form of edges. The edges correspond to the side surfaces of the material sheets due to the overlap lying respectively on top of directly adjacent material sheets. An example of an overlapping laying and joining of material sheets that is undesirable for aesthetic reasons is the waterproofing of swimming pools. The material sheets used in this application are typically PVC membranes. The edges resulting from the overlapping laying and joining of such PVC membranes in the joint material surface can be concealed by applying a seam sealer of liquid PVC after joining the material sheets. This softens the step-like seam transition at the edges. Furthermore, this prevents dirt from accumulating at the seam transition. However, a complete concealment of the overlap seams or the edges in the joint material surface in the sense that the edges are thereby ‘invisible’ cannot be achieved. In particular, when the water surface is calm and upon illumination of a swimming pool, the seam transitions are clearly visible despite the concealment.

The problems described above of overlapping laying and joining of material sheets can be avoided by laying and joining the material sheets at but joint or with the side surfaces facing one another. Thereby, directly adjacent material sheets to be joined are laid with their respective side surfaces facing one another in contact or abutting and joined to one another. The connection is hereby made using connecting pieces. These are arranged underneath the material sheets to be joined at a transition between respectively two directly adjacent material sheets to be joined. The connecting pieces are thereby inserted into corresponding recesses in a carpet pad or an underlay arranged between the material sheets to be joined and a ground on which the material sheets are laid for joining. The underlay can thereby also consist of sheet or web shaped material, e.g. tile sheets.

The material sheets are joined over the connecting pieces in at least two main steps. Firstly, a first of two directly adjacent material sheets to be joined to one another over a connecting piece is joined with the connecting piece. This is a conventional overlapping joining of two material sheets—one of which is a connecting piece—and can basically be carried out with an (automated) welding apparatus known from the prior art. Thereafter, the second material sheet is joined with the connecting piece. Since an additional connection is made with the other material sheet by joining the material sheets along their side surfaces facing one another, this is not a conventional overlapping connection. The joining with the second material sheet with the connecting piece and the first material sheet is carried out in several partial steps by hand using manual welding devices, often handheld hot air tools, in order to prevent damaging the visible edge of the first material sheet by excessive exposure to thermal energy (burns). A visible edge of a material sheet is thereby an upper side surface of the material sheet where the top side and a side surface of the material sheet adjoin each other. Connecting the second material sheet to the connecting piece and the first material sheet by hand is time-consuming. In order to achieve an adequate result when joining the second material sheet to the connecting piece and the first material sheet, at least two people are usually required to carry out the connection and assist each other.

### SUMMARY

Against this background, it is an object of the present disclosure to provide an improved device for thermal joining of two material sheets with a connecting piece. In particular, it would be desirable to provide a device with which the working speed can be increased. Furthermore, it would be desirable to further improve a seam quality when butt-welding the side edges of adjacent material sheets over an underlying connecting piece.

According to aspects of the present disclosure, a device for thermal joining of two respective material sheets via a connecting piece with the features of claim 1, a method for connecting two respective material sheets via a connecting piece with the features of claim 11 and a mobile connecting apparatus for connecting two respective material sheets via a connecting piece with the features of claim 13 are provided. Furthermore, advantageous embodiments can be found in the respective dependent claims.

Accordingly, a proposed device for thermal joining of respective two material sheets comprises a base body with a front edge, a rear edge opposite the front edge and two opposite longitudinal edges, wherein a top surface side and a bottom surface side opposite the top surface side of the base body respectively extend between the front edge and the rear edge as well as between the two longitudinal edges. Hereby, the top surface side, the bottom surface side, the front edge, the rear edge and the two longitudinal edges can completely border a volume of the base body. The device can in particular with respect to the base body be configured to be guided between the top side of the connecting piece and the bottom sides of the material sheets. Thereby, the top surface side of the base body can face the bottom sides of the material sheets and the bottom surface side can face the top side of the connecting piece. Furthermore, the base body of the device can be configured to guide the material sheets from the front edge to the rear edge over the top surface side, at least in areas of their respective bottom side adjacent to their side surfaces, such that, starting from the front edge of the base body, the material sheets are guided separated from one another over at least a quarter, in particular over at least a half, in particular over at least two-thirds and in particular over at least three-quarters of a maximum extension of the base body between the front edge and the rear edge with their respective side surfaces facing one another. Additionally, the device can be configured to simultaneously heat at least partially the bottom side of the material sheets, the top side of the connecting piece and the respective side surface of the material sheets facing one another so as to (simultaneously) produce respectively parallel connections, in particular parallel weld seams, between each of the two material sheets and the connecting piece as well as between the material sheets.

In other words, the proposed device can be configured as a butt-welding device. In the context of the present disclosure, a welding device can also be construed as a device for thermal joining. The proposed device can be configured to slide between the two material sheets arranged butt-to-butt and the underlying connecting strip, thereby producing two parallel weld seams on both sides in one step. Simultaneously, the two butt ends, i.e. the (short) side surfaces of the material sheets facing on another, can be at least partially welded or thermally joined together.

The proposed solution can provide one or more of the following advantages. By being able to produce the thermal joining of the two material sheets and preferably also the strip-shaped connecting piece in a single operation, several work steps can be saved. This can reduce the working time and increase efficiency, for example when producing butt weld seams. A further advantage can be an improved weld quality. The thermal connection can be formed in a single pass operation with constant process parameters. A further advantage can be a physiological relief for the operator, in particular in combination of the device with a movable joining apparatus. A further advantage can be a pure or same-material-type connection of the material sheets. In contrast to conventional procedures, in which, for example, an additional adhesive is employed or a seam transition or overlap is concealed with a joint sealant, a thermally produced pure or single-material-type connection can be produced. Furthermore, there can be advantages for the companies using the device, such as expanding their product range, strengthening their market position as an innovative company and ensuring an exclusive solution, for example for (seamless) swimming pools or sports surfaces, in particular in outdoor areas.

The base body can be configured to guide the two material sheets over the top surface side of the base body such that the two material sheets abut against each other at the second end edge or at the rear edge of the base body (again) with their side surfaces facing one another. It is particularly preferred that the parallel weld seams between the bottom side of the material sheets and the top side of the connecting piece as well as between the two material sheets merge into one another without a gap and form a common weld seam.

The device can be configured as a hot air heating device or as part of a hot air heating device, in particular in the form of a hot air nozzle. The material sheets and the connecting piece are thereby subjected to hot air for heating via the device. Alternatively, a device according to aspects of the invention can be configured as a contact heating device. The heating of the material sheets and the connecting piece is thereby caused by heat transfer by thermal contact between the device, in particular the base body of the device, and the material sheets and the connecting piece. Due to the generally occurring physical contact between a device according to aspects of the invention and the material sheets as well as the connecting piece upon connecting the material sheets over the connecting piece, also in an embodiment of the device as a hot air nozzle or the like heat can also be transferred by thermal contact between the device and the material sheets as well as the connecting piece. Generally, however, the material sheets and the connecting piece are heated by the application of hot air.

The device is preferably formed from a heat-resistant material. If the device is configured as a contact heating device, in implementation of a material with good thermal conductivity is further preferred. The device can be configured in several pieces or as a single piece, wherein an implementation as a single piece is preferred. The device can be manufactured by an additive manufacturing process (‘3D printing’).

In the context of the present disclosure, the front edge, the rear edge and the side edges of a base body of the device can not only be contemplated as line-shaped, but alternatively and/or additionally as areal/planar. The front edge, the rear edge, the longitudinal edges, the top surface side and the bottom surface side can be segmented, i.e. respectively formed from at least two segments. The front edge is that edge of the base body of the device which, when two material sheets are joined over a connecting piece, is arranged at the front when the device moves relative to the material sheets and the connecting piece in a (feed) direction along the side surfaces of the material sheets facing each other and faces the direction of movement. Accordingly, the rear edge is located in the direction of movement at the rear and faces away from the direction of movement. For joining of respective two material sheets over a connecting piece, the device can be moved relative to the material sheets and the connecting piece along the side surfaces of the material sheets facing each other, wherein the material sheets and the connecting piece are considered to be at rest. Alternatively, however, the material sheets and the connecting piece can also be moved relative to the device considered to be at rest.

The proposed device for connecting respective two material sheets over a connecting piece can, in particular, enable the material sheets to be joined over the connecting piece in one pass. An advantage of the proposed solution can, in particular, be that no further work or process steps are required for joining the first material sheet to the second material sheet. Moreover, both the first material sheet and the second material sheet can be joined with the connecting piece in one pass.

The base body of the device can be configured as a hollow body and can comprise at least one opening for outlet of hot air from the hollow body at the rear edge of the base body into a space between the rear edge of the base body, the top side of the connecting piece and the bottom sides of the material sheets. The base body or the entire device can thus be configured in the form of a hot air nozzle. Via the at least one air outlet at the rear edge, hot air can get between the material sheets and the connecting piece and thus heat the material sheets on the bottom side and the connecting piece on the top side.

The top surface side and/or the bottom surface side of the base body of the device can comprise at least one opening for the outlet of hot air from the base body.

Through one or more openings on the top surface side of the base body hot air can exit the base body towards a bottom side of the material sheets. As a result, the bottom sides of the material sheets can already be prewarmed or preheated before the (main) part of the hot air, which exits the base body through the at least one opening at the rear edge of the base body, contacts the bottom sides of the material sheets and heats them further. Through one or more openings on the bottom surface of the base body hot air can exit the base body towards the top side of the connecting piece. As a result, the top side of the connecting piece can already be prewarmed or preheated before the (main) part of the hot air, which exits the base body through the at least one opening at the rear edge of the base body, contacts the top side of the material sheets and heats them further. By providing additional openings for the outlet of hot air from the base body on its top surface side and/or on its bottom surface side, heating of the material sheets and of the connecting piece to be joined can be further improved, for example with regard to the speed with which the heating takes place. The working speed can thus be further increased.

A fin can protrude from the top surface side of the base body. The fin can extend parallel to the maximum extension of the base body at least partially between the front edge and the rear edge. Hot air can be introduced into the base body through the fin from an end of the fin that faces away from the top surface side. The fin is thus at least partially configured as a hollow body and/or comprises one or more hollow bodies through which hot air can be introduced into the base body configured as a hollow body. The hollow body or bodies of the fin preferably extend through the fin between the end of the fin on the top surface side and a respective transition to the hollow body of the base body.

The fin can be configured in one piece with the base body. A maximum extension of the fin in a direction parallel to a maximum extension of the base body between its two longitudinal edges can be shorter than the maximum extension of the base body between its two longitudinal edges. For example, the fin can extend parallel to the maximum extension of the base body between its longitudinal edges over at most one quarter, in particular over at most one fifth and in particular over at most one sixth of the maximum extension of the base body between the longitudinal edges. Preferably, the maximum extension of the fin in a direction parallel to the maximum extension of the base body between its two longitudinal edges can also be significantly smaller than a maximum extension of the fin in a direction parallel to a maximum extension of the base body between its front edge and rear edge. For example, the maximum extension of the fin in a direction parallel to the maximum extension of the base body between its longitudinal edges is only one third, in particular at most one quarter and in particular at most one sixth of a maximum extension of the fin in a direction parallel to a maximum extension of the base body between its front edge and rear edge. For example, the fin does not extend in a direction parallel to the maximum extension of the base body between its front edge and rear edge as far as the rear edge of the base body, but preferably ends at least at a distance of one sixth of the maximum extension of the base body between its front edge and rear edge in front of the rear edge of the base body.

The top surface side of the base body can be configured to guide the material sheets past the fin such that thermal contact between a lower side edge of a material sheet at a transition between the respective bottom side to the respective side surface of the material sheets along an extension of the fin between the front edge and the rear edge is established only on a second half, in particular only on a last third and in particular only on a last quarter of an extension of the fin between the front edge and the rear edge of the base body. With such an embodiment the risk of an excessive input of thermal energy under thermal contact between the facing side surfaces of the material sheets and the fin and any possibly resulting damage to the material sheets in the area of the respective side surface or joint surface for a butt-to-butt joint seam of the side surfaces can be reduced.

The end of the fin can be connected to a shaft tube, which is configured for guiding an air flow to the end of the fin and at the same time for fixing it to a hot air device in a region of the hot air device for the outlet of the hot air flow to be generated by the hot air device. The shaft tube can hereby, for example, be configured to be placed and/or fixed on an outlet end of a heating tube of a hot air device provided for the outlet of hot air. The hot air device can in turn be part of a hot air welding apparatus, e.g. an automatic hot air welding machine. In other words, the shaft tube can be provided at a top side of the fin. On the one hand, it can serve to fix the device and/or serve as the inlet opening for hot air.

The bottom surface of the base body can be concave. The bottom surface side of the base body can in a respective embodiment thus be curved inwards. This results in a cavity between the bottom surface side of the base body and the top side of the connecting piece, into which hot air can be introduced if at least one corresponding opening is provided in the bottom surface side for hot air to exit the base body. This can further improve top side preheating and top side heating of the connecting piece overall. The cavity is thereby preferably not completely closed in order to avoid air jam in the cavity. In particular, the cavity can be open at least in the region of the rear edge of the base body. The base body can hereby at a transition between the bottom surface side and the rear edge be configured such that for example there is at least one opening of the cavity to a surrounding between the bottom surface of the base body and the top side of the connecting piece.

The device can be configured as an electrically heated contact heating device. In this embodiment, the top side of the connecting piece and/or the bottom side of the material sheets can be heated by transferring heat energy under thermal contact—with simultaneous physical contact—between the base body of the device and the connecting piece as well as the material sheets. Thereby, at least larger parts of the top surface side of the base body can be in (successive) thermal contact with parts of the respective bottom side of the material sheets and, at the same time, substantial parts of the bottom surface side of the base body can be in (successive) thermal contact with parts of the top side of the connecting piece.

For example, it can be provided that the device is at least partially configured as a directly electrically heated heating plate (heating sheet). The heating plate or the heating plates can thereby form at least part of the top surface side and/or the bottom surface side of the base body of the device. Alternatively or additionally, it can be provided that the device for thermal joining of respectively two material sheets is configured at least partially as a solid block of material made of a thermally conductive material comprising at least one receptacle for at least one electrical heating element. Such an electrical heating element can be a heating cartridge, which can for example be arranged at least partially in the base body in a bore provided in a preferably solid part of the base body of the device.

At least two guiding profiles can protrude outwards from the top surface side of the base body, wherein the guiding profiles can extend at least partially between the front edge and the rear edge over the first top surface side. The guiding profiles can be configured to guide the material sheets for at least one quarter, in particular at least one half, in particular at least two-thirds and in particular at least three-quarters of the maximum extension of the base body between the front edge and the rear edge with their respective side surfaces separated from one another over the top surface side and to bring the material sheets towards the rear edge into contact with the side surfaces abutting against each other.

By providing guiding profiles on the top surface side, the guidance of the material sheets over the top surface side of the base body of the device and thereby, in particular, the connecting of the material sheets at the rear edge of the base body can be improved such that the material sheets (re)abut each other with the side surfaces facing one another. Further, if the device comprises a fin, the guiding of the material sheets over the top surface side of the base body of the device can also be improved with regard to generally avoiding thermal contact or at least avoiding excessive input of thermal energy into the side surfaces under thermal contact between the side surfaces of the material sheets facing one another and the fin of the device.

According to a further aspect, a method for thermal joining of respective two material sheets over a strip-shaped connecting piece is proposed comprising the following steps:
a. providing at least one connecting piece lying areally on a bottom side and two material sheets to be joined to each other over the connecting piece, which are arranged with a respective side surface facing one another abutting against each other at least partially with a respective bottom side areally on a top side of the connecting piece;
b. at least partial (successive and/or simultaneous) heating of the bottom sides of the material sheets, the side surfaces of the material sheets and the top side of the connecting piece in a connecting region such that in the connecting region between each of the material sheets and the connecting piece as well as between the material sheets, simultaneously zones of partially melted and/or melted material of the material sheets and of partially melted and/or melted material of the connecting piece parallel to one another are formed, in particular which merge into one another without a gap;
c. applying pressure in the connecting region to the material sheets from their top sides immediately after the heating to simultaneously form a connection (joining seam or weld seam) between each of the material sheets and the connecting piece as well as a further connection (joining seam or weld seam) between the material sheets upon cooling of the by the heating partially melted and/or melted material of the material sheets and the partially melted and/or melted material of the connecting piece in the zones, wherein the weld seams extend parallel to one another without a gap.

An advantage of the proposed method for thermal joining of two material sheets over a connecting piece can be that the material sheets are joined to one another quickly and efficiently in a single pass with the respective side surfaces facing each other butt-to-butt. Moreover, a connection with the underlying connecting piece can be formed in the same process step.

The heating of the bottom side of the material sheets, the side surfaces of the material sheets and the top side of the connecting piece in the connecting region can be performed by a device for thermal joining of respective two material sheets according to one of the embodiments or according to any combination of the embodiments as described in the preceding sections.

According to a further aspect of the present disclosure, a movable joining apparatus, in particular a movable welding apparatus, for joining respective two material sheets over a strip-shaped connecting piece lying areally on a bottom side, wherein the material sheets are arranged with a respective side surface facing one another abutting against one another at least partially with a bottom side lying areally on a top side of the connecting piece, comprises at least a support frame and a moving frame formed from in each case at least one pressure roller and moving roller arranged on the support frame. The traveling roller can hereby be arranged on the support frame in a front region of the support frame and the pressure roller in a rear region of the support frame with respect to a travel direction or feed direction of the joining apparatus along the side surfaces of the material sheets upon joining the material sheets. Such a movable joining apparatus can comprise a device for thermal joining of respective two material sheets according to one of the embodiments or according to any combination of the embodiments as described in the preceding sections.

The device for thermal joining of two material sheets can be configured to be adjustable in height relative to the chassis of the joining apparatus. The device can thus with respect to a plane in which the welding apparatus can be moved on a flat ground, be configured to be adjustable in a vertical direction with respect to this plane. An advantage of this embodiment can be that material sheets of different thicknesses can be processed. For example, plastic sealing sheets usually have a lower thickness than sports surface sheets for outdoor use.

The joining apparatus can comprise at least one guide aid (also referred to as a guide device) arranged in front and/or behind the device in the preferred travel direction or movement or feed direction of the joining apparatus for visually indicating the position of the side surfaces of the material sheets facing one another and abutting against each other.

This makes it easier for an operator to orient the device for thermally joining respective two material sheets along the side surface facing one another of the material sheets to be joined at the begin of the joining process. If a joining apparatus according to aspects of the invention is provided as a semi-automatic machine, i.e. is to be guided by an operator, this makes it easier for an operator to guide the joining apparatus along the side surfaces facing one another of the material sheets to be connected when joining the material sheets with the joining apparatus. A guide aid can be provided integrally with a traveling roller and/or a pressure roller.

It is to be understood that the features mentioned above and those to be explained below may be used not only in the combination respectively indicated, but also in other combinations or separately, without departing from the scope of the present invention.

Exemplary embodiments of aspects of the invention are illustrated in the following drawings and are explained in more detail in the following description. Further advantages, features and details of aspects of the invention will be apparent from the claims, the following description of preferred embodiments and from the drawings, in which same or elements with similar function are denoted by the same reference signs.

### BRIEF DESCRIPTION OF THE DRAWINGS

In the following:

FIG. 1 shows is a schematic illustration of an initial situation when joining respective two material sheets over a connecting piece;

FIG. 2 shows a first perspective view of an embodiment of a device for thermal joining respective two material sheets over a strip-shaped connecting piece lying areally on a bottom side in the form of a hot air nozzle;

FIG. 3 shows a second perspective view of the device of FIG. 2;

FIG. 4 shows a rear view of the device of FIG. 2 and FIG. 3;

FIG. 5 shows a first perspective view of a further embodiment of a device for thermal joining of respective two material sheets over a strip-shaped connecting piece lying areally on a bottom side in the form of contact heating device;

FIG. 6 shows a second perspective view of the device of FIG. 5;

FIG. 7 shows a rear view of the device of FIG. 5 and FIG. 6;

FIG. 8 shows a first perspective illustration of an embodiment of a joining apparatus, in particular a movable welding apparatus, in a position in preparation of a joining process for joining two material sheets over a connecting piece;

FIG. 9 shows a second perspective illustration of the movable joining apparatus of

FIG. 8 in a position during joining two material sheets; and

FIG. 10 shows a schematic illustration of the two material sheets of FIG. 1 to be joined over a connecting piece after a connection has been established.

### DETAILED DESCRIPTION

FIG. 1 illustrates the initial or starting situation when connecting two material sheets 100 and 200 over an areally lying connecting piece 300. The arrangement of the two material sheets 100 and 200 and the connecting piece 300, shown in a cross section of parallel longitudinal directions of the material sheets 100 and 200 as well as the connecting piece, lies planar on a flat ground not shown in FIG. 1 for the sake of clarity. The ground can for example be the bottom of a swimming pool. The connecting piece 300 thereby lies in a recess provided for this purpose in an underlay or carpet pad for the material sheets 100 and 200, which is also not shown in FIG. 1. The underlay can be formed from tile sheets laid out planar on the ground. The connecting piece 300 lies areally on the ground with a bottom side 302 (=bottom side of the connecting piece). On an upper side 301 (=top side of the connecting piece) of the connecting piece 300 opposite the bottom side 302, edge-side regions of a bottom side 102 of the material sheet 100 and a bottom side 202 of the material sheet 200 lie areally on top in the vicinity of respective side surfaces of the material sheets 100 and 200 facing one another. Beyond the respective edge side regions of the material sheets 100 and 200, the bottom sides lie planar on a top side of the underlay not shown. The material sheets 100 and 200 abut against each other with their respective side surfaces facing one another. In the schematic illustration in FIG. 1, this is illustrated by the abutting edge or surface 150.

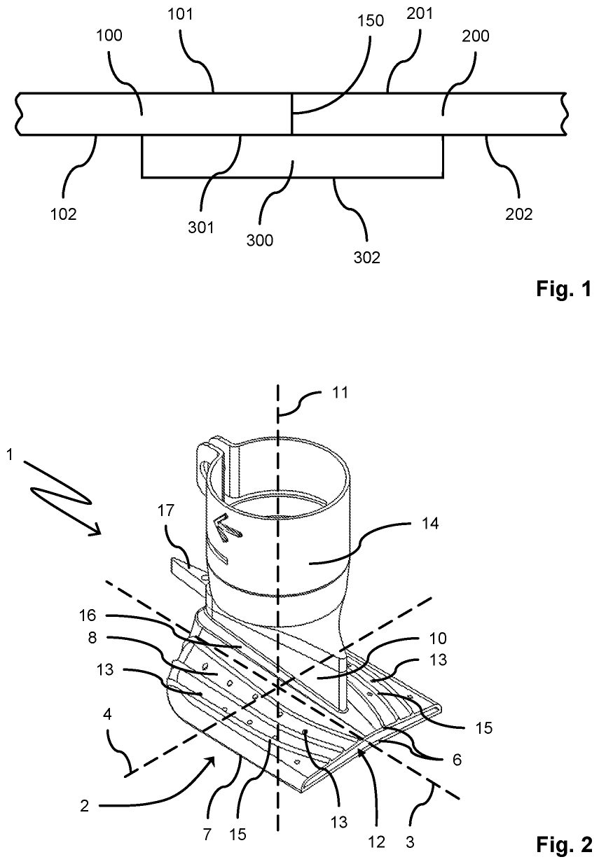

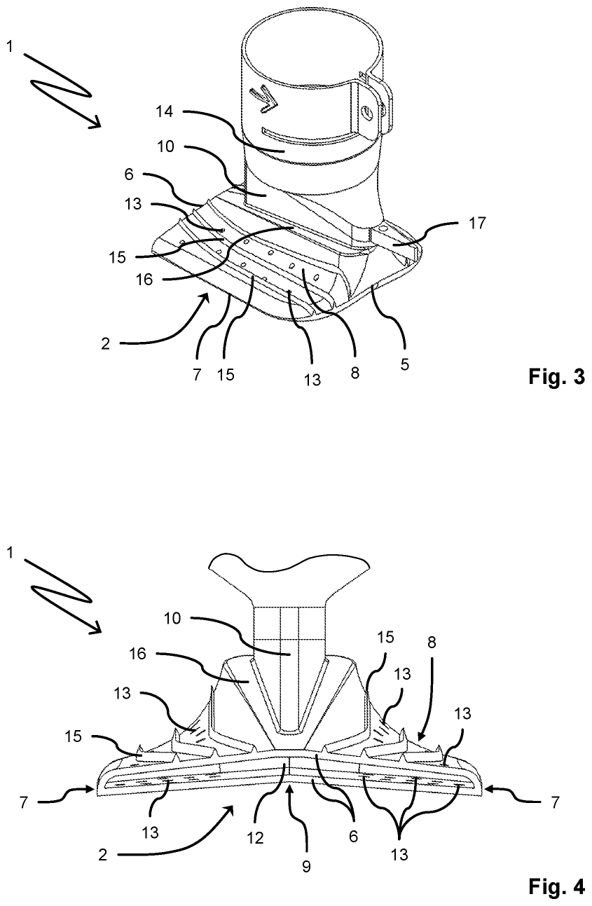

FIGS. 2 to 4 show an exemplary embodiment of a device 1 for joining of respective two material sheets, i.e. a first material sheet 100 and a second material sheet 200, over a planar connecting piece 300 in the form of a hot air nozzle. FIG. 2 and FIG. 3 show the device 1 in a respective different perspective view. FIG. 4 shows the device 1 in a rear view. In FIG. 2, axes 4, 5 and 11 are shown to describe the device 1, which are not shown in FIG. 3 and FIG. 4 for the sake of clarity. For the same reason, FIG. 2 to FIG. 4 do not illustrate the material sheets 100 and 200 or the connecting piece 300.

The device 1 comprises a base body 2. In the shown embodiment of the device 1 in the form of a hot air nozzle, the base body 2 is configured as a hollow body. The base body 2 extends in a plane spanned by a longitudinal axis 3 and a first transverse axis 4 in a direction of the longitudinal axis 3 between a front edge 5 and a rear edge 6 and further in a direction along the first transverse axis 4 between two longitudinal edges 7. In FIG. 1, the base body 2 is bordered or delimited on the top side by a top surface side 8 and on the bottom side by a bottom surface side 9. The top surface side 8 and the bottom surface side 9 respectively extend between the front edge 5 and the rear edge 6 and between the two longitudinal edges 7. The top surface side 8 and the bottom surface side 9 thereby lie opposite one another spaced apart in a direction along a second transverse axis 11.

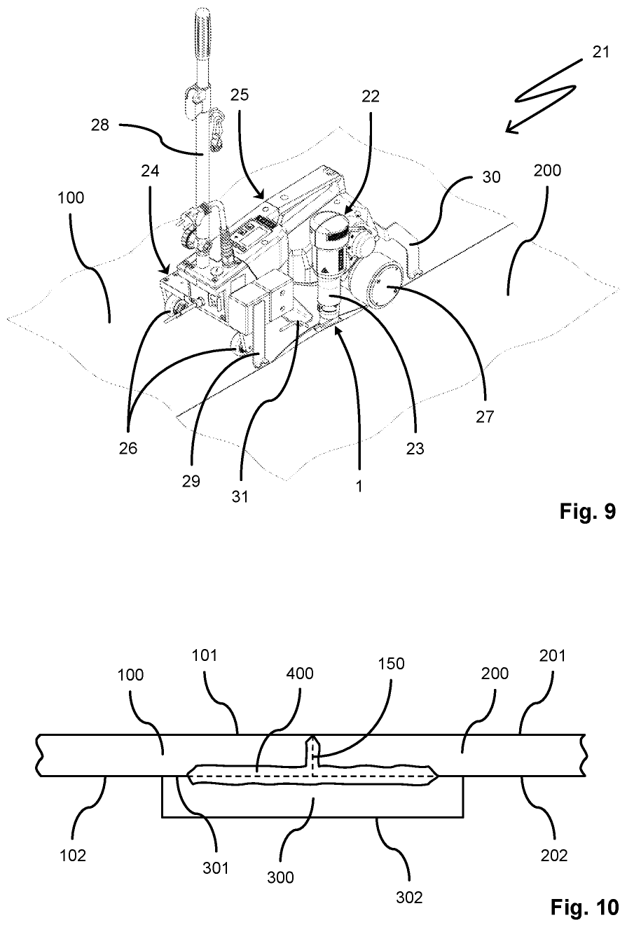

A fin 10 protrudes from the top surface side 8 in a direction of the second transverse axis 11. The fin 10 extends in a direction along the longitudinal axis 3 between the front edge 5 and the rear edge 6. The longitudinal extension of the fin 10 is hereby preferably smaller than the maximum longitudinal extension of the base body 2 between the front edge 5 and the rear edge 6 parallel to the longitudinal axis 3. The longitudinal extent of the fin 10 between the front edge 5 and the rear edge 6 ends at a distance in front of the rear edge 6. The longitudinal extent of the fin 10 between the first front edge 5 and the rear edge 6 begins at the front edge 5. Similar to the base body 2, the fin 10 is also configured to be hollow. Thereby hot air can be introduced through the fin 10 into the base body 2. At an end of the fin 10 facing away from the top surface side 8 in a direction of the second transverse axis 11, the fin 10 merges continuously into a shaft tube 14. Starting from the fin 10, the shaft tube 14 extends in a direction along the second transverse axis 11. The shaft tube 14 allows hot air to be guided to the fin 10 and through the fin 10 further into the base body 2. Moreover, the shaft tube 14 allows fixing the entire device 1 to an end region of a hot air generating apparatus 22 provided for the outlet of hot air, for example in the area of an outlet opening for hot air of a hot air tube 23 of the hot air generating apparatus 22 (see also FIG. 8 and FIG. 9). The shaft tube 14 can be configured similar to a pipe clamp at an axial end facing away from the fin 10 along the second transverse axis 11 for fixing it to a hot air tube 23 or the like.

At a front end of the longitudinal extension of the fin 10 on the side of the front edge 5, a flag or tip 17 projecting parallel to the longitudinal axis 3 from the fin 10 beyond the front edge 5 can extend from the fin 10. The optional tip 17 serves as an indicator for orienting the device 1 or a movable welding apparatus 21 (see also FIG. 8 and

FIG. 9) with the device 1 when preparing the joining of two material sheets 100, 200 over a connecting piece 300 in the direction of the side surfaces of the material sheets 100 and 200 facing one another and abutting against each other. When joining two material sheets 100 and 200 over a connecting piece 300, the tip 17 facilitates guiding the device 1 or a welding apparatus 21 with the device 1 as a whole along the side surfaces of the material sheets 100 and 200 facing one another and abutting against each other. The tip 17 thus points in a preferred direction of movement of the device 1 or of a welding apparatus 21 with the device 1 as a whole.

When joining two material sheets 100 and 200 along their side surfaces facing one another and abutting against each other (abutting edges) over a connecting piece 300 with the device 1, the bottom surface side 9 of the base body 2 faces a top side 301 of the connecting piece 300 and is at least partially in thermal (and physical) contact therewith. The top surface side of the base body of the device 1 is also at least partially in thermal (and physical) contact with a respective bottom side 102, 202 of the two material sheets 100, 200. In the case of the device 1 configured in the form of a hot air nozzle corresponding to FIG. 2 to FIG. 4, however, the direct physical contact is limited and is not decisive for the bottom side heating of the material sheets 100, 200 and the top side heating of the connecting piece 300. The fin 10 is arranged between the two material sheets 100 and 200. The top surface side 8 of the base body of the device 1 is divided by the fin 10 into two longitudinal partial top sides, which lie opposite each other in a direction along the first transverse axis 4 over the fin 10 or over a plane spanned by the longitudinal axis 3 and the second transverse axis 11.

The rear edge 6 can be regarded as being divided into two partial rear edges (without individual reference numerals), which border an outlet opening 12 and thereby converge towards the longitudinal edges 7 of the base body. The outlet opening 12 at the rear edge 6 of the base body enables hot air to exit from the base body 2 into the surrounding. The outlet of hot air from the base body 2 thereby takes place essentially in a direction parallel to the longitudinal axis 3 opposite to the feed direction or preferred direction of movement of the device 1 upon joining two material sheets 100, 200 over a connecting piece 300 and thus between the top side 301 of the connecting piece 300 and the bottom sides 102, 202 of the two material sheets 100, 200. In addition to the outlet opening 12 at the rear edge 6, the base body 2 can comprise various further outlet openings 13 on the top surface side 8 and/or on the bottom surface side 9 for the outlet of hot air from the base body 2. The hot air emerging from the base body 2 from outlet openings 13 in the top surface side 8 is thereby output towards the bottom side 302 of one of the material sheets 100, 200. The hot air emerging from outlet openings 13 in the bottom surface side 9 is thereby output towards the top side 301 of the connecting piece. These further outlet openings 13 serve to preheat the connecting piece 300 and material sheets 100, 200. The top side heating of the connecting piece 300 and the bottom side heating of the material sheets 100, 200 can be carried out primarily by hot air exiting from the outlet opening 12 at the rear edge 6 of the base body 2. A main portion of the amount of hot air that can be introduced into the base body 2 exits the base body 2 through the outlet opening 12 at the rear edge 6.

On the top surface side 8 of the base body 2, optionally on both sides of the fin respectively 3 guiding profiles 15 can be provided. The guiding profiles 15 extend from the front edge 5 in the direction towards the rear edge 6, optionally up to the rear edge 6, over the top surface side 8. In the embodiment shown, the guiding profiles 15 extend starting from the front edge 5 initially parallel to the longitudinal axis 3 over the top surface side 8 and finally at an (acute) angle towards the longitudinal axis 3, wherein they end in front of or at the rear edge 6 of the base body 2. The guiding profiles 15 serve to bring together two material sheets 100, 200, which are guided on both sides of the fin 10 past the fin 10 over the top surface side 8 (close) to the rear edge 6, so that the two material sheets 100, 200 are brought back into contact with each other in the area of the rear edge 6 with their butt surfaces or side surfaces facing on another or abutting against each other. In the exemplary embodiment shown in FIG. 2 to FIG. 4, the guiding profiles 15 have a triangular cross-section. However, other embodiments are also conceivable.

At a transition between the top surface side 8 and the fin 10 protruding from the top surface side 8, a flange or shoulder 16 running around the fin 10 can be provided as part of the top surface side 8. In the embodiment shown, the shoulder 16 lies in one plane, which intersects the plane spanned by the longitudinal axis 3 and the first transverse axis 4 at an acute angle and is inclined downwards from the front edge 5 of the base body 2 to the rear edge 6. In a cross section by the base body 2 perpendicular to the longitudinal axis 3, the first support surface side on both sides of the fin 10 comprises respectively a cross-sectional profile that rises from the longitudinal edges 7 to the shoulder 16. In a front region of the base body 2 near the front edge 5, the cross-sectional profile can be concave and the slope is greatest directly at the transition to the shoulder 16. At the transition to the shoulder 16, wherein the cross-sectional profile in the region of the shoulder 16 runs respectively parallel to the first transverse axis 4, the slope of the cross-sectional profile can change abruptly. Towards the rear edge 6 of the base body 2, the concavity of the cross-sectional profile of the top surface side 8 can decrease on both sides of the fin 10 between the longitudinal edges 7 and the shoulder 16 and can change near the rear edge 6 into a straight line that rises only slightly on both sides of the fin 10 between the longitudinal edges 7 and the shoulder 16. In the embodiment shown, the base body 2 has its greatest thickness in the region of the shoulder 16 near the front edge 5. The exemplary embodiment of the device 1 described above can be clearly seen in the perspective illustrations and the rear view of the device 1 in FIG. 4. This embodiment can serve to avoid pronounced thermal contact between the respective facing side surfaces of two material sheets 100 and 200 guided over the top surface side 8 of the base body 2 of the device 1 with the fin 10. Otherwise, there is a risk of damage to the material sheets 100 and 200 on their respective side surfaces facing one another by excessive input of thermal energy due to excessive thermal contact with the fin 10. In particular, damage to the top side edges of the side surfaces of the material sheets 100 and 200 facing on another, resulting from the top sides 101 and 201 of the two material sheets 100 and 200 when they are joined, which is detrimental to the visual impression of the overall surface of the joined material sheets 100 and 200, should thereby be avoided. A limited thermal or limited direct physical contact between the side surfaces of the material sheets 100 and 200 facing one another and the fin 10 near the rear edge 6 of the base body 2, i.e. in a vicinity of the rear end of the extension of the fin 10 along the longitudinal axis 3, is however possible without excessive thermal stress occurring.

In addition, it can be seen from the rear view of the device 1 in FIG. 4 that the bottom surface side 9 of the base body 2 of the device 1 can be concave. This results in a cavity between the bottom surface side 9 of the base body 2 and the top side 301 of the connecting piece 300 when two material sheets 100 and 200 are joined with the device 1. Hot air can be inserted from the base body 2 into the cavity via the openings 13 in the bottom surface side 9 of the base body 2. The cavity can be open towards the rear edge 6 of the base body 2 and/or towards the front edge 5 of the device 1. This avoids air jam in the cavity, such that hot air can be continuously inserted from the base body 2 into the cavity. The possibility of being able to continuously insert hot air into a cavity between the bottom surface side 9 of the base body 2 of the device 1 and a top side 301 of a leads to improved preheating of the connecting piece 300.

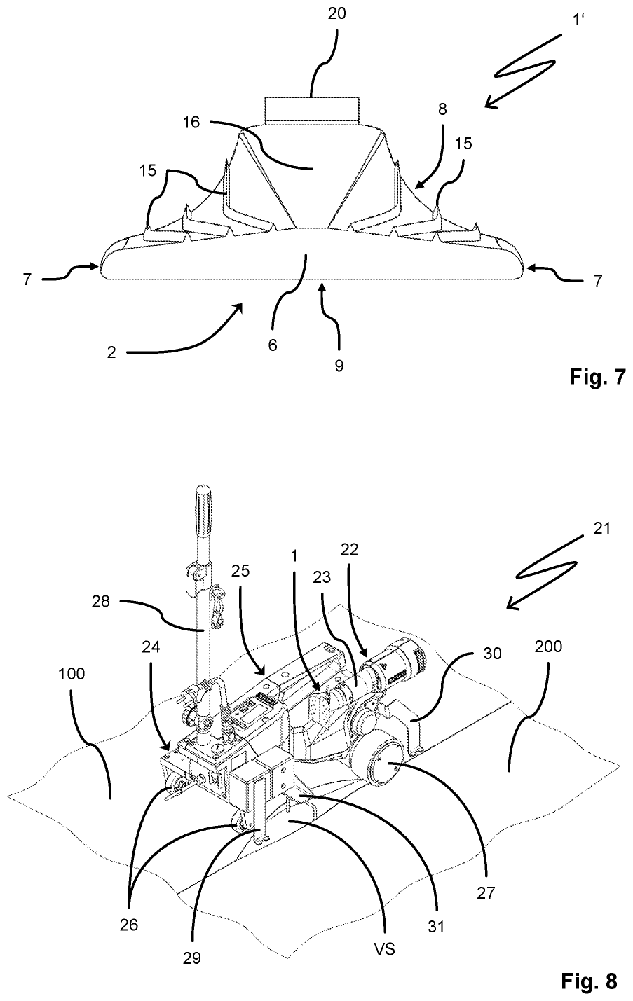

FIG. 5 to FIG. 7 show a further embodiment of a device 1′ according to aspects of the invention for joining respective two material sheets 100 and 200 over an areal connecting piece 300, now configured as a contact heating device. The illustration type of the device 1′ configured as a contact heating device according to FIGS. 5 to FIG. 7 corresponds to the illustration type of the device 1 configured as a hot air nozzle according to FIGS. 2 to FIG. 4. For the sake of conciseness, the device 1′ configured as a contact heating device of FIG. 5 to FIG. 7 is described in the following primarily in view of the differences with respect to the device 1 configured as a hot air nozzle of FIGS. 2 to FIG. 4.

The base body 2 of the device 1′ configured as a contact heating device can be configured as a solid, one-piece block of material made of a thermally conductive material. The bottom surface side 9 of the base body 2 of the device 1′ can be flat, apart from a respective limited transition area to the longitudinal edges 7 of the base body 2 and the front edge 5 of the base body 2. This serves to maximize thermal contact between a top side 301 of a connecting piece 300 and the base body 2 of the device 1′ for top-side heating of the connecting piece 300. The configuration of the top surface side 8 of the base body 2 of the device 1′ can basically correspond to the top surface side 8 of the device 1, including identically configured guiding profiles 15 on the top surface side 8. However, the device 1′ does not need a hollow fin 10 and no outlet openings 12 or 13 for hot air.

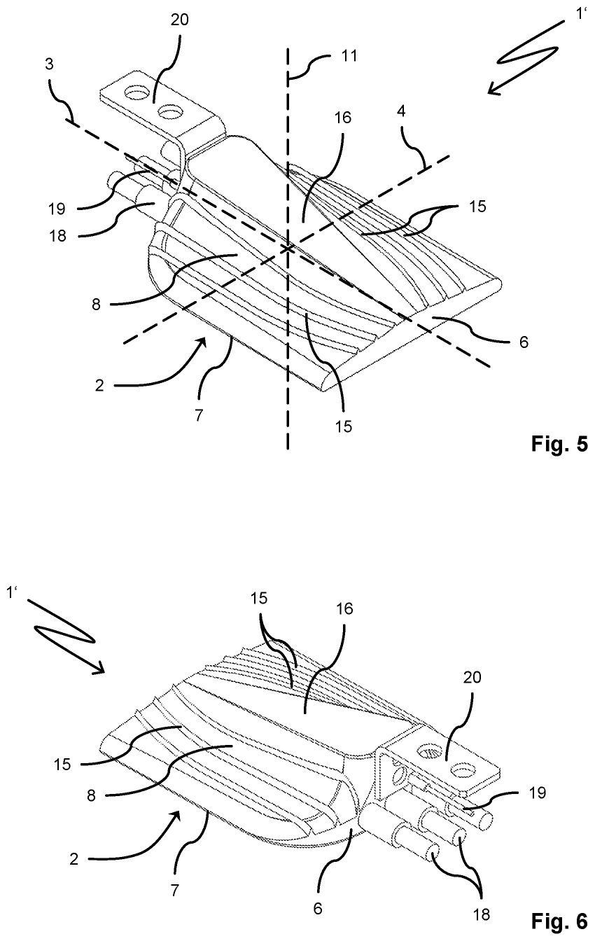

The rear edge 6 of the base body 2 of the device 1′ can be configured to be flat, straight and elongated-planar. Starting from the front edge 5 of the base body 2 of the device 1′, one or more bores, in the shown example in total four bores, can extend into the base body parallel to the longitudinal axis 3. Three of the bores are respectively provided for receiving a heating cartridge 18 for heating the base body 2 of the device 1′. The further, fourth bore serves as a receptacle for a thermal probe 19. The four bores are not visible in the illustrations of the device 1′ in FIG. 5 to FIG. 7. In FIG. 5 and FIG. 6, parts of the three heating cartridges 18 and the thermal probe 19 are already visible protruding from the bores. At the front edge 5 of the base body 2, the device 1′ can further comprise an angled holder 20 for connecting the device 1′ to a welding apparatus or the like.

FIG. 8 and FIG. 9 show an embodiment of a movable joining or welding apparatus 21 for joining two material sheets 100 and 200 over a connecting piece 300. In addition to the welding apparatus 21 itself, FIG. 8 and FIG. 9 also illustrate two material sheets 100 and 200 to be joined over a connecting piece 300. In the embodiment shown, the joining apparatus is a hot air welding apparatus with a hot air device (hot air blower) 22 for generating a hot air flow. The hot air device 22 is mounted rotatably/pivotably with respect to a support frame 24 and a housing 25 of the welding apparatus 21. The hot air device 22 can therefore be pivoted from a rest position, as illustrated in FIG. 8, to an operating position, as illustrated in FIG. 9. The hot air device 22 comprises a hot air tube 23, wherein a device 1 for joining respective two material sheets 100, 200 over a connecting piece 300 corresponding to the device 1 shown in FIGS. 2 to 5 is arranged at an outlet end of the hot air tube 23 or of the hot air device 22 for hot air generated by the hot air device 22.

Furthermore, the welding apparatus 21 can comprise traveling rollers 26, two of which are visible in FIG. 8 and FIG. 9, a pressure roller 27, which, connected to an electric drive, also serves as a drive roller, a material sheet lifting device 31, a front guide aid 29, a rear guide aid 30 and a guide rod 28. The guide aids 29, 30 facilitate the alignment or orientation of the welding apparatus 21 along the respective side surfaces of the material sheets 100 and 200 facing one another ang abutting against each other in preparation for joining the material sheets 100 and 200 by the welding apparatus 21 and guiding the welding apparatus 21 along the side surfaces of the material sheets 100 and 200 during the joining of the material sheets 100 and 200. Thereby, the welding apparatus 21 can be guided by an operator via the guide rod 28. The front guiding aid 29 is at the front in the sense that the front guiding aid 29 is arranged close to a front end of the welding apparatus 21. The front end of the welding apparatus 21 is that (longitudinal) end of the welding apparatus 21 which is at the front in a preferred direction of movement of the welding apparatus 21 when joining material sheets 100 and 200 in the preferred direction of movement. A rear end of the welding apparatus 21 is an opposite (longitudinal) end of the welding apparatus 21 to the front end. Accordingly, the rear guide aid 30 is arranged close to the rear end of the welding apparatus 21. The two guide aids 29, 30 are arranged laterally on a longitudinal side of the welding apparatus 21, wherein the hot air device 22 is also arranged on the welding apparatus 21 on this longitudinal side.

In FIG. 8, the welding apparatus is shown in a position during the preparation of a joining of the two material sheets 100, 200 over the connecting piece 300. The hot air device 22 with the device 1 is lifted up in the rest position. With the optional material sheet lifting device 31, the material sheets 100, 200, which abut with a respective side surface facing each other, are locally spread apart, i.e. they are locally lifted slightly on the edge side from the connecting piece 300 located below and brought out of contact with each other. This allows positioning the device 1 with its base body 2 between the connecting piece 300 and the two material sheets 100, 200 by moving down the hot air device 22 of the welding apparatus 21 with the device 1 from the rest position into the working position.

In FIG. 9, the hot air device 22 is shown in the working position, wherein the material sheet lifting device 31 is moved up in a rest position, i.e. it no longer engages locally between the two material sheets 100, 200 and spreads them out. The material sheet lifting device 31 can be lifted up automatically when the welding apparatus 21 is set in motion or starts. In the working position, the device 1 of the hot air device 22 of the welding apparatus 21 is positioned with its base body 2 between the material sheets 100, 200 and the connecting piece 300. Starting from the position shown in FIG. 9, the hot air device 22 of the welding apparatus 21 is put into operation and the welding apparatus 21 is set in motion along the side surfaces of the material sheets 100, 200 facing one another and abutting against each other. The material sheets 100, 200 are thereby successively heated in sections from the bottom side and the connecting piece 300 is successively heated in sections from the top side by providing hot air generated with the hot air device 22 via the device 1 configured as a hot air nozzle. Immediately after the heating, pressure can be successively applied by the pressure roller 27 from the top sides 101, 201 of the material sheets 100, 200 onto heated areas of the material sheets 100, 200 and the connecting piece 300 in order to join the material sheets 100, 200 and the connecting piece together. The connection of the material sheets 100, 200 via the connecting piece is advantageously carried out in one pass. Further work and/or process steps are not necessarily required.

In FIG. 10, based on FIG. 1 as an illustration of the starting situation, the result of a joining of respective two material sheets 100 and 200 over a connecting piece 300 is illustrated schematically. Parallel weld seams are formed between each of the two material sheets 100, 200 and the connecting piece 300 as well as between the two material sheets 100, 200, which preferably form a common weld seam SN. In the embodiment shown, the weld seam SN is cooled molten material of the two material sheets 100, 200 and the connecting piece 300.

In conclusion, with the solutions proposed herein, a further improved device can be provided for thermal joining of a first material sheet and a second material sheet over a connecting piece and further for a butt joint between the first material sheet and the second material sheet. With the proposed solution, the working speed can be increased. In particular, the proposed solution enables the welds to be made in a single operation.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

What is claimed is:

1. A device for thermal joining of respective two material sheets over a strip-shaped connecting piece lying areally on a bottom side, wherein the material sheets are arranged with a respective side surface facing one another abutting against each other at least partially with a respective bottom side lying areally on a top side of the connecting piece,
wherein the device comprises a base body with a front edge, a rear edge opposite the front edge and two opposite longitudinal edges,
wherein a top surface side and a bottom surface side opposite the top surface side of the base body respectively extend between the front edge and the rear edge as well as between the two longitudinal edges,
wherein the top surface side, the bottom surface side, the front edge, the rear edge and the two longitudinal edges entirely border a volume of the base body,
wherein the device is configured to be guided with the base body between the top side of the connecting piece and the bottom sides of the material sheets with the top surface side facing towards the bottom sides of the material sheets and the bottom surface side facing towards the top side of the connecting piece and can be passed,
wherein the base body is configured to guide the material sheets at least in areas of their respective bottom sides adjacent to their side surfaces from the front edge to the rear edge over the top surface side such that the material sheets are guided starting from the front edge over at least a quarter of a maximum extension of the base body between the front edge and the rear edge with their respective side surfaces facing one another separated from one another, and
wherein the device is configured to simultaneously heat at least partially the bottom side of the material sheets, the top side of the connecting piece and the respective side surface of the material sheets facing one another so as to produce respectively between each of the two material sheets and the connecting piece as well as between the material sheets parallel connections.

2. The device according to claim 1, wherein the base body is configured as a hollow body and comprises at least one opening for outlet of hot air from the hollow body at the rear edge of the base body into a space between the rear edge of the base body, the top side of the connecting piece and the bottom sides of the material sheets.

3. The device according to claim 2, wherein the top surface side and/or the bottom surface side comprises at least one opening for outlet of hot air from the base body.

4. The device according to claim 2, wherein a fin protrudes from the top surface side of the base body,
wherein the fin extends parallel to the maximum extension of the base body at least partially between the front edge and the rear edge, and
wherein hot air can be introduced into the base body through the fin from an end of the fin facing away from the top surface side.

5. The device according to claim 4, characterized in that the top surface side of the base body is configured to guide the material sheets past the fin such that thermal contact with a side edge of a material sheet at a transition between the respective bottom side to the respective side surface of the material sheets along an extension of the fin between the front edge and the rear edge is established on at least one of only on a second half, and/or only on a last third, and/or only on a last quarter of an extension of the fin between the front edge and the rear edge of the base body.

6. The device according to claim 4, wherein a shaft tube is connected to the end of the fin, which is configured for guiding an air flow to the end of the fin and at the same time for fixing to a hot air device in a region of the hot air device for the outlet of the hot air flow to be generated by the hot air device.

7. The device according to claim 1, wherein the bottom surface side of the base body is concave.

8. The device according to claim 1, wherein the device is configured as an electrically heated contact heating device.

9. The device according to claim 8, wherein the device is at least partially configured as a directly electrically heated heating plate or the device is at least partially configured as a solid block of material made of a thermally conductive material comprising at least one receptacle for at least one electrical heating element.

10. The device according to claim 1, wherein at least two guiding profiles protrude outwards from the top surface side of the base body,
wherein the guiding profiles extend at least partially between the front edge and the rear edge over the first top surface side, and
wherein the guiding profiles are configured to guide the material sheets for the at least one quarter of the maximum extension of the base body between the front edge and the rear edge with their respective side surfaces separated from one another over the top surface side and to bring the material sheets towards the rear edge into contact with the side surfaces abutting against each other.

11. A method for joining of respective two material sheets over a strip-shaped connecting piece, comprising the steps:
providing a connecting piece lying areally on an bottom side and two material sheets to be joined over the connecting piece, which are arranged with a respective side surface facing one another abutting against each other at least partially with a respective bottom side lying areally on a top side of the connecting piece;
at least partial heating of the respective bottom sides of the material sheets, the side surfaces of the material sheets and the top side of the connecting piece in a connecting region such that in the connecting region between each of the material sheets and the connecting piece as well as between the material sheets simultaneously zones of partially melted and/or melted material of the material sheets and of partially melted and/or melted material of the connecting piece parallel to one another are formed in the connecting region, in particular which merge into one another without a gap; and
applying pressure in the connecting region to the material sheets from their top sides immediately after the heating to simultaneously form a connection between each of the material sheets and the connecting piece as well as a further connection between the material sheets upon cooling of the by heating partially melted and/or melted material of the material sheets and the partially melted and/or melted material of the connecting piece in the zones, wherein the connections extend parallel to one another.

12. The method according to claim 11, wherein the heating of the' bottom side of the material sheets, the side surfaces of the material sheets and the top side of the connecting piece in the connecting region is carried out by a device for thermal joining.

13. A movable welding apparatus for thermal joining of respective two material sheets over a strip-shaped connecting piece lying areally on a bottom side, wherein the material sheets are arranged with a respective side surface facing one another abutting against each another at least partially with a bottom side lying areally on a top side of the connecting piece,
wherein the welding apparatus comprises at least a support frame and a chassis formed by at least one pressure roller and one traveling roller arranged on the support frame,
wherein the traveling roller is arranged on the support frame in a front region of the support frame and the pressure roller is arranged in a rear region of the support frame with respect to a travel direction of the joining apparatus along the side surfaces of the material sheets upon joining the material sheets,
characterized by a device according to claim 1.

14. The movable joining apparatus according to claim 13, wherein the device is configured to be adjustable in height relative to the chassis.

15. The movable joining apparatus according to claim 13, wherein the joining apparatus comprises at least one guide aid arranged in front and/or behind the device in the travel direction of the joining apparatus for visually indicating the position of the side surfaces of the material sheets facing one another and abutting against each other.

16. The movable joining apparatus according to claim 14, wherein the joining apparatus comprises at least one guide aid arranged in front and/or behind the device in the travel direction of the joining apparatus for visually indicating the position of the side surfaces of the material sheets facing one another and abutting against each other.

17. The device according to claim 1, wherein the base body is configured to guide the material sheets at least in areas of their respective bottom sides adjacent to their side surfaces from the front edge to the rear edge over the top surface side such that the material sheets are guided starting from the front edge over at least a half of the maximum extension of the base body between the front edge and the rear edge with their respective side surfaces facing one another separated from one another.

18. The device according to claim 1, wherein the base body is configured to guide the material sheets at least in areas of their respective bottom sides adjacent to their side surfaces from the front edge to the rear edge over the top surface side such that the material sheets are guided starting from the front edge over at least two-thirds of the maximum extension of the base body between the front edge and the rear edge with their respective side surfaces facing one another separated from one another.

19. The method according to claim 11, wherein the guiding profiles are configured to guide the material sheets for at least a half of the maximum extension of the base body between the front edge and the rear edge with their respective side surfaces separated from one another over the top surface side and to bring the material sheets towards the rear edge into contact with the side surfaces abutting against each other.

20. The method according to claim 11, wherein the guiding profiles are configured to guide the material sheets for at least two-thirds of the maximum extension of the base body between the front edge and the rear edge with their respective side surfaces separated from one another over the top surface side and to bring the material sheets towards the rear edge into contact with the side surfaces abutting against each other.
